(19) United States
(12) Patent Application Publication
(10) Pub. No.: US 2008/0196632 A1
(43) Pub. Date: Aug. 21, 2008

(54) Portable Work Bench

(76) Inventors: Nicholas E. Achterberg, New Freedom, PA (US); Allison A. Nicolaidis, Perry Hall, MD (US); Robert P. Welsh, Phoenix, MD (US); David L. Wikle, York, PA (US)

Correspondence Address: THE BLACK & DECKER CORPORATION, 701 EAST JOPPA ROAD, TW199, TOWSON, MD, 21286, US

(21) Appl. No.: 12/024,487

(22) Filed: Feb. 1, 2008

Related U.S. Application Data
(60) Provisional application No. 60/890,265, filed on Feb. 16, 2007.

(51) Int. Cl. B25H 1/00

(52) U.S. Cl. 108/28

(57) ABSTRACT

An improved portable work bench includes a beam, legs for supporting the beam, a bracket for supporting at least one of an accessory and a power tool, and a handle assembly connected to the beam. The handle assembly is movable between a retracted position near the beam and an extended position away from the beam.

### CROSS-REFERENCE TO RELATED APPLICATION

The present application derives priority from U.S. Application No. 60/890,265, filed Feb. 16, 2007, which is wholly incorporated by reference.

### FIELD OF THE INVENTION

This invention relates generally to work benches and more particularly to a portable work bench that can support a power tool and a workpiece.

### BACKGROUND OF THE INVENTION

It is common in the construction industry for users to bring their power tools to the work site. Thus, the users require a work surface at the work site to support the power tools for use. Preferably the work surface is at a certain height so that the user can comfortably use the power tool. In addition, the work surface should also be sufficiently portable to be easily moved around a work site.

In the past, users have disposed their power tools on sheets of wood which are in turn supported by two or more sawhorses. This arrangement, however, lacks the strength and stability for efficient operation, as well as being difficult to set up and move around the work site.

Accordingly, different support stands or work benches have been proposed in order to provide a portable work surface that can support a power tool. Some of these prior art solutions have been described in U.S. Pat. Nos. 1,864,840, 4,860,807, 4,874,025, 4,974,651, 5,193,598, and 5,421,231. However, these prior art solutions do not provide a platform supporting the power tool which can be moved horizontally so that the power tool can be moved without moving the workpiece.

Other prior art solutions, such as the one described in U.S. Pat. No. 5,592,981, provide a platform supporting the power tool which can be moved horizontally so that the power tool can be moved without moving the workpiece. However, they require that the user insert and slide the platform from the end of the workbench towards the desired position on the workbench.

### SUMMARY OF THE INVENTION

In accordance with the present invention, an improved portable work bench is employed. The workbench may include a beam having first and second ends, legs for supporting the beam, a bracket for supporting at least one of an accessory and a power tool, an extendible arm contacting at least one of the bracket and the beam, the arm being movable between an extended position and a retracted position, a handle disposed on the arm, and a detent mechanism for maintaining the arm in the retracted position.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 is a perspective view of a portable work bench of the present invention;

FIG. 2 is a partial side view of the work bench of FIG. 1;

FIG. 3 illustrates an alternate mode of operation of the workbench of FIG. 1; and

FIG. 4 is a cross-sectional view of a leg locking mechanism.

### DETAILED DESCRIPTION

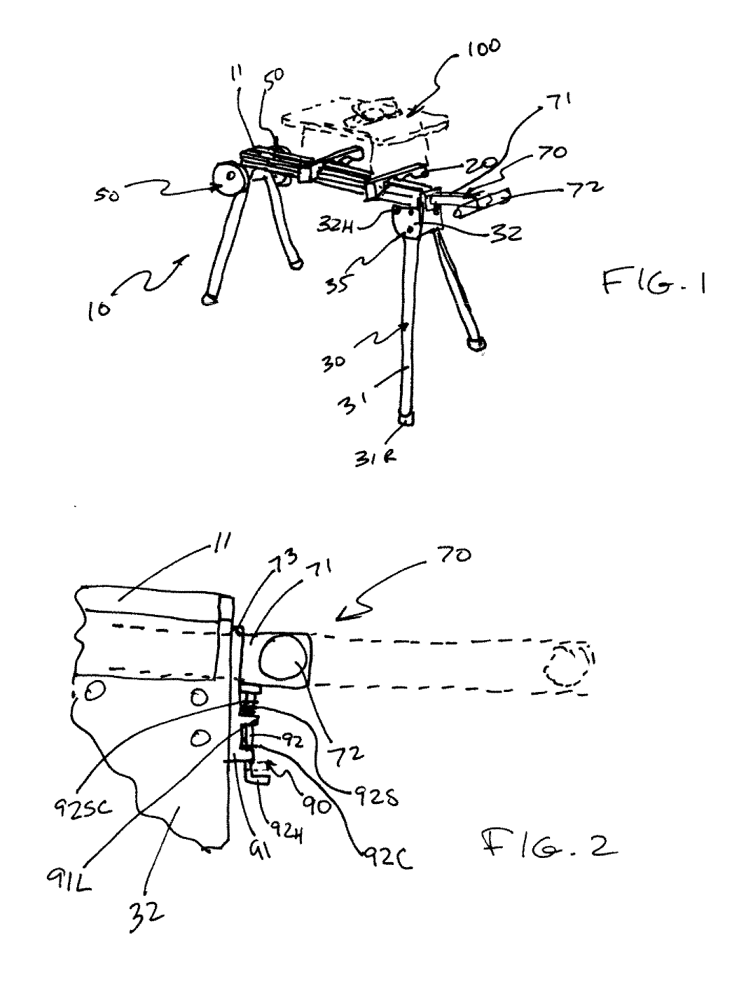

The invention is now described with reference to the accompanying figures, wherein like numerals designate like parts. Referring to FIG. 1, a portable work bench 10 of the present invention is designed to carry a table saw 100 and/or a workpiece (not shown). However, persons skilled in the art will recognize that the work bench 10 can support any power tool, such as a sliding compound miter saw, a drill press, a chop saw, etc., any hand tools, or anything else that may need to be supported.

The work bench 10 has a structural body 11 and at least one mounting bracket 20 disposed on the structural body 11. Preferably, the structural body 11 supports two mounting brackets 20. For further information on work bench 10 and its components, including but not limited to structural body 11 and mounting bracket(s) 20, persons skilled in the art are referred to U.S. Pat. No. 7,036,540, which is hereby wholly incorporated herein by reference.

In addition, the work bench 10 may have leg assemblies 30 for supporting the structural body 11 and mounting brackets 20 (and thus the table saw 100 and/or workpiece). Referring to FIGS. 1 and 3-4, the leg assemblies 30 may include a leg 31 pivotally connected to the body 11 via brackets 32. Preferably, leg 31 is made of metal, such as extruded aluminum. The cross-section of leg 31 may be round or ob-round (with two opposing substantially flat sides.

Leg 31 may have an end 31R, which may be made of an elastomeric material, a plastic or rubber. Preferably, the end 31R is made of a material that prevents slippage of the leg 31 along a floor or other supporting surface.

Bracket 32 may wrap around the end of body 11. Preferably, bracket 32 is made of metal, such as sheet steel. Bracket 32 may also be shaped so that it matches the upper profile of body 11. Preferably, bracket 32 is attached to body 11 via screws, as disclosed in U.S. Pat. No. 7,036,540.

It is preferable to provide leg assembly 30 with a detent mechanism 35 to maintain the leg 31 in predetermined positions. Different detent mechanisms 35 may be found in U.S. Pat. Nos. 4,605,099 and 5,592,981, which are hereby incorporated by reference. Preferably, detent mechanism 35 includes a detent pin 35P, which engages a hole 32H in bracket 32. Detent pin 35P may extend through leg 31 and lever arm 36. Lever arm 36 preferably has a handle portion 36H. Lever arm 36 is preferably pivotably attached to leg 31 via pivot joint 37 at a point between handle portion 36H and the point of contact between lever arm 36 and detent pin 35P. Persons skilled in the art will recognize that, when a user pushes on handle portion 36H, lever arm 36 will rotate and pull detent pin 35P out of hole 32H.

A spring 36S may be disposed between leg 31 and/or lever arm 36, for biasing detent pin 35P towards engagement with hole. A retainer 38, such as a C- or E-clip, may be disposed between pin 35P and lever arm 36, to prevent escape of the pin 35P.

Persons skilled in the art are referred to U.S. Pat. Nos. 601,613, 691,050, 4,954,008, 5,421,272, which are hereby incorporated by reference, for further information on similar detent mechanisms.

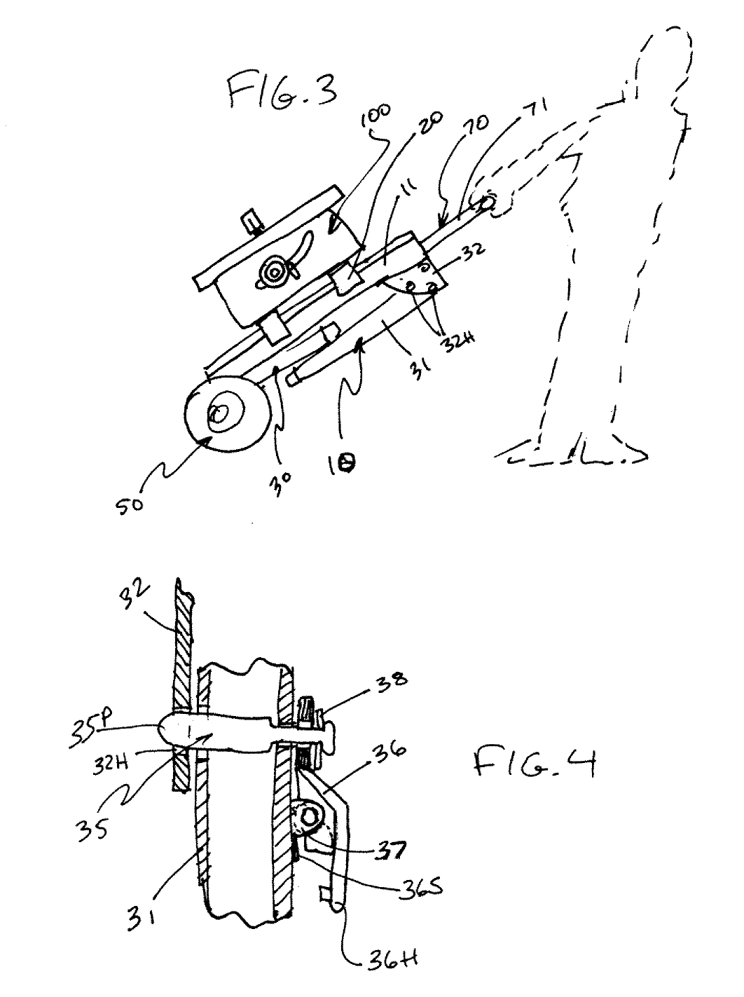

Persons skilled in the art should recognize that holes 32H are preferably disposed so detent mechanism 35 can retain leg 31 in an open position (such as that shown in FIG. 1) or a closed position (such as that shown in FIG. 3).

Portable workbench 10 may have at least one wheel assembly 50 and preferably two wheel assemblies 50. As shown in FIGS. 1 and 3 wheel assemblies 50 are preferably disposed at the end or near the end of beam 11. Persons skilled in the art are referred to US Publication No. 20040250903, which is wholly incorporated by reference, for further information on wheel assembly 50.

Referring to FIGS. 1-3, workbench 10 may have a handle assembly 70. A handle assembly 70 may include an extension arm 71, which may slidably telescope within beam 11 in a retracted position (shown in solid lines in FIG. 2) and extends beyond the end of beam 11 in an extended position (shown in broken lines in FIG. 2). Extension arm 71 may be made of a composite material, or a metal, such as steel or aluminum.

A handle 72 may be disposed at one end of extension arm 71. Handle 72 preferably has a rubber covering for user comfort.

It is desirable to maintain handle assembly 70 in the retracted position, yet provide a means for easy movement towards the extended position. Accordingly, extension arm 71 preferably carries a detent 73 that engages a notch on beam 11, bracket 32 and/or a plate 91 disposed on bracket 32. Persons skilled in the art shall recognize that detent 73 may be spring-biased towards such notch.

Persons skilled in the art will also recognize that such arrangement allows extension arm 71 to remain stationary in the retracted position, until the user overcomes the holding force of detent 73 and moves extension arm 71 (and thus handle 72) to the extended position. Persons skilled in the art should recognize that detent 73 may be disposed on beam 11, bracket 32 and/or plate 91, whereas the notch for receiving detent 73 may be disposed on extension arm 71.

It is desirable to lock extension arm 71 when in the extended position. Accordingly, an arm locking mechanism 90 is discussed below. Referring to FIGS. 1-2, arm locking mechanism 90 is preferably disposed on bracket 32. Arm locking mechanism 90 may include a plate 91, which is preferably bolted onto bracket 32 via bolts. Plate 91 may be made of plastic, and may have an opening for allowing arm 71 to extend therethrough.

In addition, plate 91 may slidably support a latch 92. Latch 92 may carry a clip 92SC. A spring 92S may be disposed on or around latch 92, and preferably between clip 92SC and a ledge 91L of plate 91. Persons skilled in the art will recognize that such arrangement biases latch 92 towards extension arm 71.

Accordingly, as the user moves extension arm 71 towards the extended position, a hole (not shown) in extension arm 71 moves closer to latch 92. Due to the bias created by spring 92S, latch 92 preferably engages the hole, locking extension arm 71 (and thus handle 72) in an extended position.

The user can unlock extension arm 71 to move handle 72 towards the retracted position. The user would preferably move latch 92 downwardly to disengage latch 92 from the hole in the extension arm 71. Persons skilled in the art will recognize that it is preferably to provide a clip 92C on latch 92 to prevent latch 92 from escaping plate 91.

With such arrangement, a person can fold legs 31, extend handle assembly 70, lift portable workbench 10 by handle assembly 70 and roll portable workbench 10 via wheel assembly 50, as shown in FIG. 3. Portable workbench 10 may even be rolled with a power tool 100 disposed thereon.

Persons skilled in the art may recognize other additions or alternatives to the means disclosed herein. However, all these additions and/or alterations are considered to be equivalents of the present invention.

1. A work bench comprising:
a beam;
legs for supporting the beam;
a mounting bracket for supporting at least one of an accessory and a power tool;
a handle assembly connected to the beam, the handle assembly being movable between a retracted position near the beam and an extended position away from the beam.

2. The work bench of claim 1, further comprising a first wheel disposed on the beam.

3. The work bench of claim 1, wherein the legs are pivotable relative to the beam between opened and closed positions.

4. The work bench of claim 1, wherein the handle assembly comprises an extension arm and a handle disposed on the extension arm.

5. The work bench of claim 4, wherein the extension arm telescopes within the beam.

6. The work bench of claim 4, further comprising a detent disposed on one of the extension arm and the beam, and a notch for receiving the detent disposed on the other of the extension arm and the beam.

7. The work bench of claim 4, further comprising an arm locking mechanism disposed on the beam for locking the extension arm in the extended position.

8. The work bench of claim 7, wherein the arm locking mechanism comprises a latch disposed on the bracket for engaging a hole in the extension arm.

9. The work bench of claim 8, wherein the arm locking mechanism further comprises a spring for biasing the latch towards the extension arm.

10. The work bench of claim 1, further comprising a handle assembly locking mechanism disposed on the beam for locking the handle assembly in the extended position.

11. The work bench of claim 10, wherein the handle assembly locking mechanism comprises a latch disposed on the beam for engaging a hole in the handle assembly

12. The work bench of claim 11, wherein the handle assembly locking mechanism further comprises a spring for biasing the latch towards the handle assembly.

13. The work bench of claim 1, further comprising a second wheel disposed on the beam.

14. The work bench of claim 1, further comprising a first connecting bracket for connecting two legs to the beam.

15. The work bench of claim 14, further comprising a first wheel disposed on the first connecting bracket.

16. The work bench of claim 15, further comprising a second wheel disposed on the first connecting bracket.

17. The work bench of claim 14, further comprising a detent disposed on one of the extension arm and at least one of the first connecting bracket and the beam, and a notch for receiving the detent disposed on the other of the extension arm, and the at least one of the first connecting bracket and the beam.

18. The work bench of claim 14, further comprising an arm locking mechanism disposed on the first connecting bracket for locking the extension arm in the extended position.

19. The work bench of claim 18, wherein the arm locking mechanism comprises a latch disposed on the first connecting bracket for engaging a hole in the extension arm.
